(19) United States
(12) Patent Application Publication
(10) Pub. No.: US 2023/0079940 A1
(43) Pub. Date: Mar. 16, 2023

(54) GUIDANCE DEVICE, NON-TRANSITORY COMPUTER-READABLE RECORDING MEDIUM, AND GUIDANCE METHOD

(71) Applicant: Mitsubishi Electric Corporation, Tokyo (JP)

(72) Inventor: Shoki MIYAGAWA, TOKYO (JP)

(73) Assignee: Mitsubishi Electric Corporation, Tokyo (JP)

(21) Appl. No.: 17/992,094

(22) Filed: Nov. 22, 2022

Related U.S. Application Data
(63) Continuation of application No. PCT/JP2020/033002, filed on Sep. 1, 2020.

(51) Int. Cl. G06T 11/20; G06F 9/451; G06F 3/14; H04S 7/00

(52) U.S. Cl. CPC G06T 11/203; G06F 9/453; G06F 3/14; H04S 7/303; H04S 2400/11

(57) ABSTRACT

A guidance device includes: a processor, and a memory to store a program which, when executed by the processor, performs processes of: performing a search for a suitable value of a parameter for guiding an attention of a user to a target position by repeating a process of updating a value of the parameter so that an evaluation value approaches a predetermined value, and determining, from a result of the search, a value of the parameter for outputting at least part of an object, the evaluation value changing according to a difference between the target position and a position estimated by a user from at least part of the object when at least part of the object is output; generating output data for outputting at least part of the object, by using the determined value of the parameter; and outputting at least part of the object using the output data.

### CROSS REFERENCE TO RELATED APPLICATION

This application is a continuation of International Application No. PCT/JP2020/033002, filed on Sep. 1, 2020, the disclosure of which is incorporated herein by reference in its entirety.

### BACKGROUND OF THE INVENTION

### 1. Field of the Invention

The present disclosure relates to a guidance device, a non-transitory computer-readable recording medium, and a guidance method.

### 2. Description of the Related Art

It is known that people have an ability to estimate, on the basis of information displayed in a display region of a display, a specific position outside the display region of the display. For example, people can see part of a figure displayed on a display, imagine the entire figure, and thereby estimate a two-dimensional position away from the display. This is information presentation using a human visual cognitive process called amodal completion.

Not only in visual perception but also in auditory perception, there is a technical field called sound image localization that provides a feeling as if a sound were heard from a position where no physical speaker exists. For example, a virtual sound source can be created by applying a technique called amplitude panning to multiple speakers. A virtual sound source can be created not only by amplitude panning but also by a technique called head-related transfer function (HRTF) that needs no physical speaker.

Guidance to a specific position by information presentation using a human cognitive process as described above will be defined as position guidance. Position guidance is useful especially in situations where a person's attention is to be attracted. For example, in Patent Literature 1, a driver is assisted in driving by presenting figures for intuitively understanding the positions of preceding vehicles or pedestrians.
Patent Literature 1: Japanese Patent Application Publication No. 2015-096946

In position guidance, it is important that an error (referred to below as an estimation error) between a position estimated by a person and a position (referred to below as a target position) that is a target of guidance be small. However, it is not clear how to set parameters for a figure or a sound presented to a user to reduce the estimation error. In the case of a figure, types of parameters include angles, lengths, or the like, and in the case of a sound, types of parameters include sound volumes, sound source positions, or the like. These types of parameters should be appropriately set so that the estimation error is small.

In many conventional techniques, the parameters are empirically set so that they are objectively reasonable. However, in empirically performed position guidance, there is a problem in that while a human cognitive process such as amodal completion is used, the effect of an error on estimation caused by the process is not taken into account. Even when the target position is the same, the behavior of the cognitive process varies depending on the set of the parameters. Thus, the parameters should be determined in cognitive terms.

### SUMMARY OF THE INVENTION

Thus, one or more aspects of the present disclosure are intended to reduce a difference between a position estimated by a person and a position that is a target of guidance.

A guidance device according to an aspect of the present disclosure includes: a processor to execute a program; and a memory to store the program which, when executed by the processor, performs processes of: determining a target position that is a position to which an attention of a user is to be guided by at least part of an object output to guide the attention of the user to a certain position by using estimation by the user; determining an initial value of a parameter for outputting at least part of the object; performing a search for a suitable value of the parameter for guiding the attention of the user to the target position by repeating a process of updating a value of the parameter of a determined type from the initial value so that an evaluation value approaches a predetermined value, and determining, from a result of the search, a value of the parameter for outputting at least part of the object, the evaluation value changing according to a difference between the target position and an estimated position that is a position estimated by a user from at least part of the object when at least part of the object is output; generating output data for outputting at least part of the object, by using the determined value of the parameter; and outputting at least part of the object by using the output data.

A non-transitory computer-readable recording medium according to an aspect of the present disclosure stores a program for causing a computer to execute: determining a target position that is a position to which an attention of a user is to be guided by at least part of an object output to guide the attention of the user to a certain position by using estimation by the user; determining an initial value of a parameter for outputting at least part of the object; performing a search for a suitable value of the parameter for guiding the attention of the user to the target position by repeating a process of updating a value of the parameter of a determined type from the initial value so that an evaluation value approaches a predetermined value, and determining, from a result of the search, a value of the parameter for outputting at least part of the object, the evaluation value changing according to a difference between the target position and an estimated position that is a position estimated by a user from at least part of the object when at least part of the object is output; generating output data for outputting at least part of the object, by using the determined value of the parameter; and outputting at least part of the object by using the output data.

A guiding method according to an aspect of the present disclosure includes: determining a target position that is a position to which an attention of a user is to be guided by at least part of an object output to guide the attention of the user to a certain position by using estimation by the user; determining an initial value of a parameter for outputting at least part of the object; performing a search for a suitable value of the parameter for guiding the attention of the user to the target position by repeating a process of updating a value of the parameter of a determined type from the initial value so that an evaluation value approaches a predetermined value, and determining, from a result of the search, a value of the parameter for outputting at least part of the object, the evaluation value changing according to a difference between the target position and an estimated position that is a position estimated by a user from at least part of the object when at least part of the object is output; generating output data for outputting at least part of the object, by using the determined value of the parameter; and outputting at least part of the object by using the output data.

With one or more aspects of the present disclosure, it is possible to reduce a difference between a position estimated by a person and a position that is a target of guidance.

### BRIEF DESCRIPTION OF DRAWINGS

FIG. 1 is a block diagram schematically illustrating a configuration of a guidance device according to a first embodiment.

FIG. 2 is a schematic diagram illustrating an example of an isosceles triangle selected as an object.

FIG. 3 is a schematic diagram for explaining reference values for the isosceles triangle.

FIG. 4 is a schematic diagram for explaining an example of a process in a reference value measurement unit.

FIG. 5 is a schematic diagram illustrating an example of a comparison in location between the isosceles triangle at the values of parameters before search and the isosceles triangle at the values of the parameters after the search.

FIG. 6 is a block diagram schematically illustrating a hardware configuration example of the guidance device.

FIG. 7 is a flowchart illustrating a process from selection of objects to measurement of reference values in the first embodiment.

FIG. 8 is a flowchart illustrating a process from determination of a target position to output of the objects in the first embodiment.

FIG. 9 is a schematic diagram illustrating an example of a circle selected as an object.

FIG. 10 is a schematic diagram illustrating an example of a line selected as an object.

FIG. 11 is a schematic diagram illustrating an example of a cone selected as an object.

FIGS. 12A and 12B are schematic diagrams illustrating an example of a moving image selected as an object.

FIG. 13 is a schematic diagram illustrating an example of a sound selected as an object.

FIG. 14 is a block diagram schematically illustrating a configuration of a guidance device according to a second embodiment.

FIG. 15 is a flowchart illustrating a process from selection of objects to measurement of reference values in the second embodiment.

FIG. 16 is a block diagram schematically illustrating a configuration of a guidance device according to a third embodiment.

FIG. 17 is a schematic diagram illustrating an example of a process by a constraint design unit in the third embodiment.

FIG. 18 is a flowchart illustrating a process from selection of objects to measurement of reference values in the third embodiment.

### DETAILED DESCRIPTION OF THE INVENTION

### First Embodiment

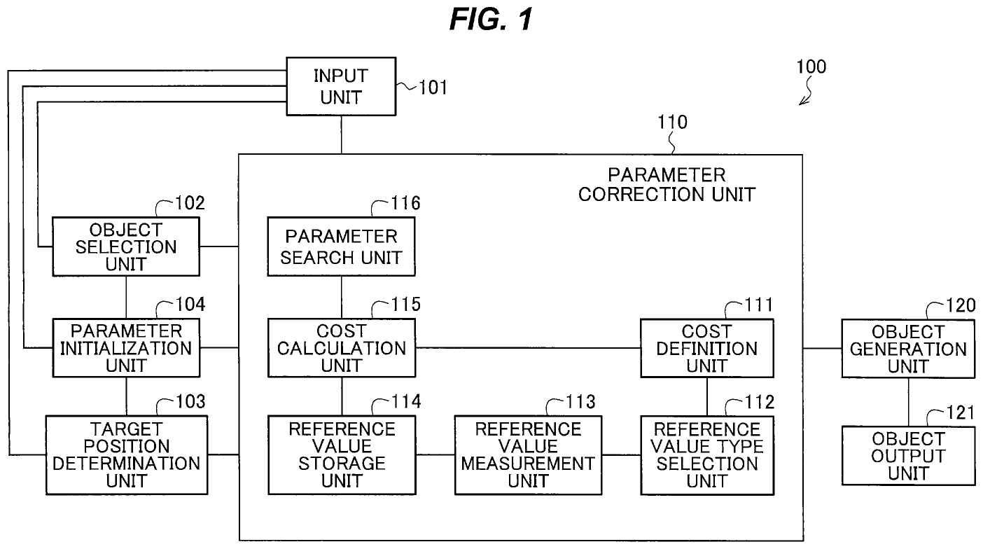

FIG. 1 is a block diagram schematically illustrating a configuration of a guidance device 100 according to a first embodiment.

The guidance device 100 includes an input unit 101, an object selection unit 102, a target position determination unit 103, a parameter initialization unit 104, a parameter correction unit 110, an object generation unit 120, and an object output unit 121.

The input unit 101 receives input from a user.

The object selection unit 102 selects one or more objects output to guide an attention of a user to a certain position by using estimation by the user, and determines one or more types of parameters for outputting at least part of the objects. For example, the object selection unit 102 selects, as means for guiding a user to a target position, one or more objects, such as figures or sounds, and determines one or more types of parameters required for generating the selected objects.

The objects may be manually selected by a user through the input unit 101 or automatically selected by the object selection unit 102 according to a specific algorithm, depending on an application that serves as the object selection unit 102. Similarly to the selection of the objects, the types of parameters may also be manually determined by a user or automatically determined according to a specific algorithm.

The target position determination unit 103 determines a target position that is a position to which the attention of the user is to be guided by at least part of the selected objects. The target position may be any one of a one-dimensional position, a two-dimensional position, and a three-dimensional position. Also, the target position may be automatically determined by using a sensor or input by a user through the input unit 101.

The parameter initialization unit 104 determines initial values of the parameters of the types determined by the object selection unit 102.

A specific example will now be described.

Non Patent Literature 1 described below describes a technique called Wedge that displays part of an isosceles triangle on a display, thereby allowing a user to estimate an apex position thereof. Thereby, it is possible to guide the attention of the user to the apex position.

Non Patent Literature 1: Gustafson, S., Baudisch, P., Gutwin, C., Irani, P., “Wedge: Clutter-Free Visualization of Off-Screen Locations”, In Proceedings of the ACM Conference on Human Factors in Computing Systems (CHI 2008), 787-796.

For example, when the technique described in Non Patent Literature 1 is used in the guidance device 100, the object selection unit 102 selects an isosceles triangle as an object, and one or more angles and one or more lengths are determined as the types of parameters.

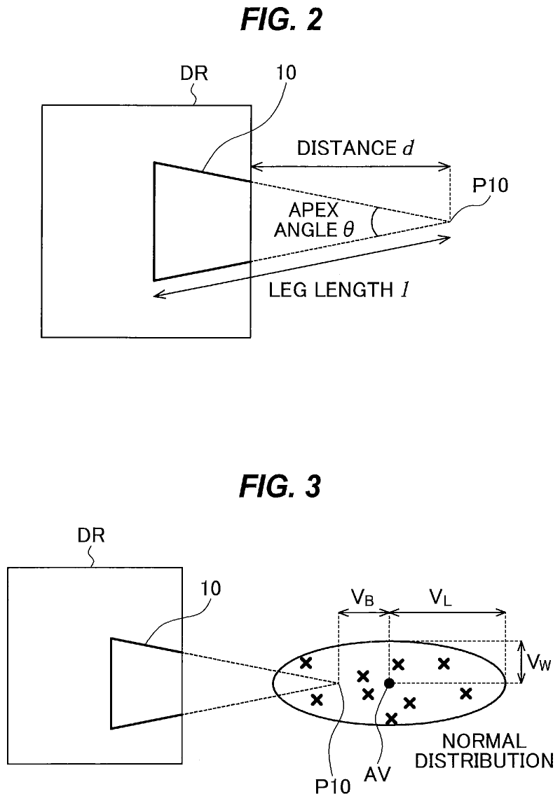

Specifically, when an isosceles triangle 10 as illustrated in FIG. 2 is selected as an object, three types, the apex angle θ, the leg length l, and the distance d from the apex P10 of the isosceles triangle 10 to a display region DR that is a region in which it is displayed on a display (not illustrated), are determined as parameters for determining the location of the isosceles triangle 10 in the display region DR.

In this case, the target position determination unit 103 determines, as the target position, a position to which the attention is to be guided by the isosceles triangle 10.

The parameter initialization unit 104 may determine random values as the initial values of the parameters of the types determined by the object selection unit 102. Also, the parameter initialization unit 104 may determine the initial values of the parameters by using techniques as described below.

For example, by using, as the initial values, values of the parameters determined by a known algorithm described in Non Patent Literature 1 or the like, parameter correction can be expected to operate relatively stably. In this case, a distance and a direction to the target position are required in the algorithm for calculating the initial values. Also, when the target position continuously changes, by determining values of the parameters corrected at time t as the initial values of the parameters at time t+1, which is a subsequent time, it is possible to reduce the amount of calculation required for parameter correction. Alternatively, instead of being automatically determined, the initial values may be input by a user through the input unit 101 in advance or during execution.

Each time both the target position determined by the target position determination unit 103 and the initial values of the parameters determined by the parameter initialization unit 104 are input to the parameter correction unit 110, the parameter correction unit 110 provides corrected values of the parameters to the object generation unit 120.

The parameter correction unit 110 includes a cost definition unit 111, a reference value type selection unit 112, a reference value measurement unit 113, a reference value storage unit 114, a cost calculation unit 115, and a parameter search unit 116.

The cost definition unit 111 defines one or more evaluation values serving as indexes in searching for values of the parameters. Here, the evaluation values are values called costs that should be minimized. For example, the cost definition unit 111 defines the costs from the selected objects and the parameters of the determined types. Each cost can be defined by using one or more reference values. As the simplest definition, there is a method of simply taking a reference value as the cost. When there are multiple reference values, the cost may be defined by a weighted sum of the reference values. In this case, it is necessary to previously adjust the weights of the terms corresponding to the respective reference values. The cost definition unit 111 may receive input of definition of the costs from a user through the input unit 101.

Since the definition of the costs is an important process that affects the quality of the parameter correction, it is preferable to theoretically design natural costs while avoiding introduction of hyperparameters, such as the aforementioned weights, as much as possible. Also, the number of costs need not be one, and multiple costs may be provided and simultaneously taken into account in parameter search.

Here, it is assumed that a distribution of estimated positions estimated from part of the isosceles triangle 10 in the display region DR as the apex P10 of the isosceles triangle 10 by multiple users is a normal distribution. In this case, as illustrated in FIG. 3, when a distance V_{B} from the apex P10 to a mean AV of the normal distribution, a length direction standard deviation V_{L} that is a standard deviation in a length direction of the normal distribution, and a width direction standard deviation V_{W} that is a standard deviation in a width direction of the normal distribution are determined, the shape of the normal distribution is uniquely determined.

When the mean AV (=d+V_{B}) coincides with the target position determined by the target position determination unit 103, and the length direction standard deviation V_{L} and width direction standard deviation V_{W} are infinitely close to zero, the normal distribution as illustrated in FIG. 3 is an ideal normal distribution with the effect of the user's cognitive process canceled.

Thus, the cost definition unit 111 may define, as a cost, a pseudo distance between the normal distribution by current values of the parameters and the ideal normal distribution. Specifically, the cost definition unit 111 may adopt, as a cost, a Kullback-Leibler divergence, which can represent a pseudo distance between normal distributions. Thereby, as the parameter search progresses, the mean AV of the normal distribution approaches the target position and the standard deviations of the normal distribution approach zero.

Specifically, it is possible that the amount of difference between the mean of the normal distribution and the target position, and the standard deviations of the normal distribution are selected as reference values, and a pseudo distance between the normal distribution and the ideal normal distribution is determined as a cost.

The reference value type selection unit 112 selects one or more types of reference values required for definition of the costs. Here, as the types of reference values, ones including effects (e.g., a bias or individual differences) of the human cognitive process should be selected to enhance the effect of the parameter correction. Also, unlike the costs, each reference value needs to be directly measurable. A reference value indicates a magnitude of difference between the determined target position and an estimated position that is a position estimated by a user from at least part of the object output according to the parameters.

For example, types of versatile reference values independent of the object selection include an error from a position estimated by a user to the target position, and a time required for the estimation by a user.

Alternatively, it is possible that the movement of the line of sight is measured, and the movement distance until identification of the target position is selected as a type of reference value.

When the effect of the position guidance in practical application is considered important, it is possible to design a task that is a purpose of a specific application (such as a task of finding the closest target position from among multiple target positions) and determine a correct answer rate, an achievement level, or the like thereof as a type of reference value.

On the other hand, not only numerical indexes based on objective evaluations but also interval scales or the like based on subjective evaluations such as five-grade evaluation for “intelligibility” may be selected as a type of reference value.

Specifically, when the cost definition unit 111 adopts, as a cost, a Kullback-Leibler divergence as described above, the distance V_{B}, length direction standard deviation V_{L}, and width direction standard deviation V_{W} are selected as the types of reference values, as illustrated in FIG. 3.

The reference value type selection unit 112 may receive input of the types of reference values from a user through the input unit 101.

The reference value measurement unit 113 performs a process of associating the parameters with the reference values of the types selected by the reference value type selection unit 112, through an experiment to one or more subjects who are users.

For example, the reference value measurement unit 113 selects values of the parameters of the determined types and measures the reference values of the selected types on the basis of at least part of the objects output by using the selected values of the parameters. Then, the reference value measurement unit 113 stores the measured reference values and the selected values of the parameters as reference value information in the reference value storage unit such that the measured reference values and the selected values of the parameters are associated with each other.

Specifically, the reference value measurement unit 113 may measure the reference values from responses of multiple subjects when the objects are presented to the subjects with various sets of values of the parameters in random order. As the number of the subjects increases, it is possible to obtain the reference values such that the reference values better reflect individual differences. Also, as the number of the sets of values of the parameters increases, the cost calculation unit 115 can obtain more accurate reference values.

At this time, the sets of values of the parameters used in the experiment may be freely determined by a user depending on the application. Although a method of changing the values of the parameters at regular intervals is the simplest, when the number of the types of parameters is large or when the load of collecting a large amount of data is large, the data may be efficiently collected by a method (e.g., Bayesian optimization or the like) of adaptively determining the next set of values of the parameters on the basis of responses of the users. The experiment environment may be either a real environment or a virtual environment such as a virtual reality (VR) environment. When the experiment is performed in a real environment, an appropriate output device, such as a display or a speaker, is selected depending on the objects or application, and reference values corresponding to responses of the users are recorded by using a measurement device. Although the same applies to the case where the experiment is performed in a virtual environment, since it is possible to perform the experiment in a physically narrow space or smoothly change the display of the objects, it is possible to efficiently obtain a larger amount of data.

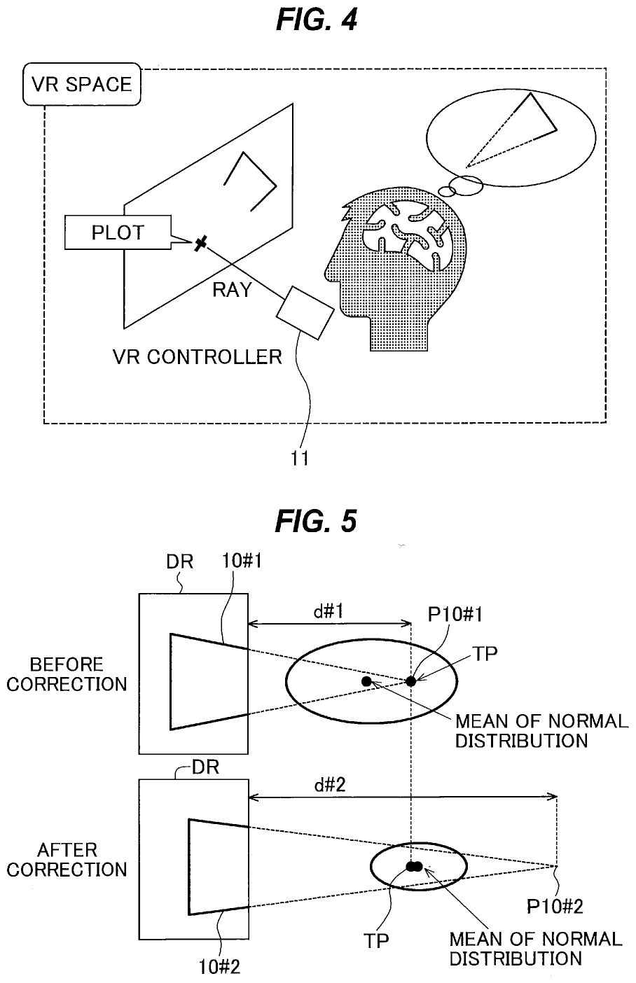

FIG. 4 is a schematic diagram for explaining an example of the process by the reference value measurement unit 113.

Here, a method of performing an experiment by using a VR space as illustrated in FIG. 4 will be described.

Users as subjects can quickly and intuitively specify the positions of points on a plane by using a light ray emitted from a VR controller 11 even when the users are physically remote. In this case, estimated positions are positions estimated by the users from an object output in a virtual reality space according to corresponding values of the parameters.

For example, in the example illustrated in FIGS. 2 and 3, for each of sets of values of the distance d, apex angle θ, and leg length l, which are the parameters, each of the distance V_{B}, length direction standard deviation V_{L}, and width direction standard deviation V_{W} is associated with the set. For example, by such association, the effect of the user's cognitive process is reflected in the reference values. For example, an experiment conducted by the inventor showed that the distance V_{B} decreases as the distance d increases, and users tend to underestimate the distance d. The correspondence data between the parameters and the reference values obtained by the experiment is stored as the reference value information in the reference value storage unit 114.

The reference value storage unit 114 stores the reference value information in which the parameters and the reference values are associated with each other. Although the data set obtained by the reference value measurement unit 113 may be simply held as the reference value information, preprocessing such as outlier removal or smoothing may be performed to improve data quality.

The cost calculation unit 115 determines reference values corresponding to values of the parameters provided from the parameter search unit 116 by referring to the reference value information stored in the reference value storage unit 114, and calculates the costs by using the determined reference values. Then, the cost calculation unit 115 provides the calculated costs to the parameter search unit 116.

For example, when reference values corresponding to the provided values of the parameters are stored in the reference value storage unit 114, the cost calculation unit 115 may simply use the reference values. On the other hand, when no reference values corresponding to the provided values of the parameters are stored in the reference value storage unit 114, the cost calculation unit 115 performs an exceptional process. For example, the cost calculation unit 115 searches the reference value storage unit 114 for neighboring values of the parameters that are values of the parameters closest to the provided values of the parameters, and uses the reference values corresponding to the neighboring values of the parameters. Alternatively, the cost calculation unit 115 may interpolate (e.g., linearly interpolate) the reference values by using multiple neighboring values of the parameters. These processes are sufficiently functional when the number of reference values stored in the reference value storage unit 114 is large and distance(s) to the neighboring values of the parameters are relatively small. The method of calculating the costs from the reference values follows the definitions previously made by the cost definition unit 111.

Specifically, the cost calculation unit 115 reads, from the reference value storage unit 114, the distance V_{B}, length direction standard deviation V_{L}, and width direction standard deviation V_{W} that are reference values corresponding to values of the parameters provided from the parameter search unit 116, and calculates the Kullback-Leibler divergence as a cost by using the reference values.

The parameter search unit 116 performs a search for suitable values of the parameters for guiding the attention of the user to the target position by repeating a process of updating the values of the parameters of the determined types from the determined initial values so that the evaluation values, which change according to a difference between the determined target position and an estimated position that is a position estimated by the user from at least part of the objects when the at least part of the objects is output, approach predetermined values (e.g., 0). Then, the parameter search unit 116 determines, from a result of the search, values of the parameters for outputting at least part of the objects.

Specifically, the parameter search unit 116 uses the target position determined by the target position determination unit 103 to update the values of the parameters from the initial values of the parameters determined by the parameter initialization unit 104, by searching for values of the parameters so that the values called costs calculated by the cost calculation unit 115 are decreased.

For example, the parameter search unit 116 performs a search for suitable values of the parameters for guiding the attention of the user to the target position by repeating a process of updating the values of the parameters from the initial values of the parameters of the determined types so as to decrease a cost that increases in value as the difference between the determined target position and an estimated position that is a position estimated by the user from at least part of the selected objects when the at least part of the objects is output, and determines, from a result of the search, values of the parameters for outputting at least part of the objects.

Specifically, the parameter search unit 116 uses the costs provided from the cost calculation unit 115 to calculate gradients of the costs for the current values of the parameters and thereby provides new values of the parameters to the cost calculation unit 115. Then, the parameter search unit 116 obtains the costs of the new values of the parameters from the cost calculation unit 115. The parameter search unit 116 repeats such a search process until the changes in the costs become small, and provides the corrected values of the parameters to the object generation unit 120.

Here, although various algorithms can be used as the method for searching for the values of the parameters, the simplest method is to gradually expand a search range (e.g., a radius of a multidimensional sphere or the like) about the current values of the parameters, refer to the reference values in the reference value storage unit 114 corresponding to values of the parameters included in the search range, and compare costs.

In general, since the costs can complexly change depending on the values of the parameters, it is not clear whether the costs converge to specific values through the search. Thus, the parameter search unit 116 may set a specific condition, such as a condition that the number of searches or the change in the costs reach given values, and determine whether to continue the search, depending on whether the condition is satisfied.

FIG. 5 is a schematic diagram illustrating an example of a comparison in location between the isosceles triangle at the values of the parameters before the search and the isosceles triangle at the values of the parameters after the search.

Before the search, the apex P10 #1 of the isosceles triangle 10 #1 coincides with the target position TP, whereas after the search, the apex P10 #2 of the isosceles triangle 10 #2 does not coincide with the target position TP. This is because, while the technique described in Non Patent Literature 1 described above treats the distance d from the display to the apex as a constant, the parameter correction unit 110 treats the distance d as a parameter and corrects its value.

Also, the apex P10 #2 of the isosceles triangle 10 #2 after the search is farther than the target position TP. This is because the tendency for the user to underestimate the distance as described above has been reflected. This shows that the effect of the cognitive process has been successfully taken care of by the correction.

The object generation unit 120 uses the values of the parameters provided from the parameter correction unit 110 to generate output data for outputting at least part of the selected objects. For example, when the objects are figures, the object generation unit 120 converts data representing figures drawn with the values of the parameters provided from the parameter correction unit 110 into a format of data provided to a drawing function of an external library. Also, when the objects are sounds, the object generation unit 120 performs signal processing or the like according to the values of the parameters provided from the parameter correction unit 110.

Specifically, the object generation unit 120 uses values of the apex angle θ, leg length l, and distance d that are the values of the parameters provided from the parameter search unit 116 to generate output data representing a figure of part of the isosceles triangle. For example, the object generation unit 120 converts graphic data representing a figure of part of the isosceles triangle into output data that is data in a raster or vector format so that it can be displayed on a display. Then, the object generation unit 120 provides the output data to the object output unit 121.

The object output unit 121 receives the output data in an available format from the object generation unit 120 and outputs at least part of the objects by using the output data.

For example, when the objects are figures, the object output unit 121 may perform display with a display or projection with a projector.

Also, when the objects are sounds, the object output unit 121 may reproduce previously recorded sounds, sounds subjected to signal processing in real time, or the like through a speaker array or a directional speaker. At this time, the object output unit 121 also performs a control regarding output timing. For example, when multiple objects are selected, the object output unit 121 needs to synchronize the times of presenting them to the user. This may be programmed to be automatically controlled, or may be directly controlled by a user through the input unit 101.

Specifically, when drawing an isosceles triangle on a display, the object output unit 121 needs to execute a function defined in an external library, such as OpenGL or OpenCV. In this case, the object output unit 121 can draw part of the isosceles triangle by providing the output data provided from the object generation unit 120 to the drawing function.

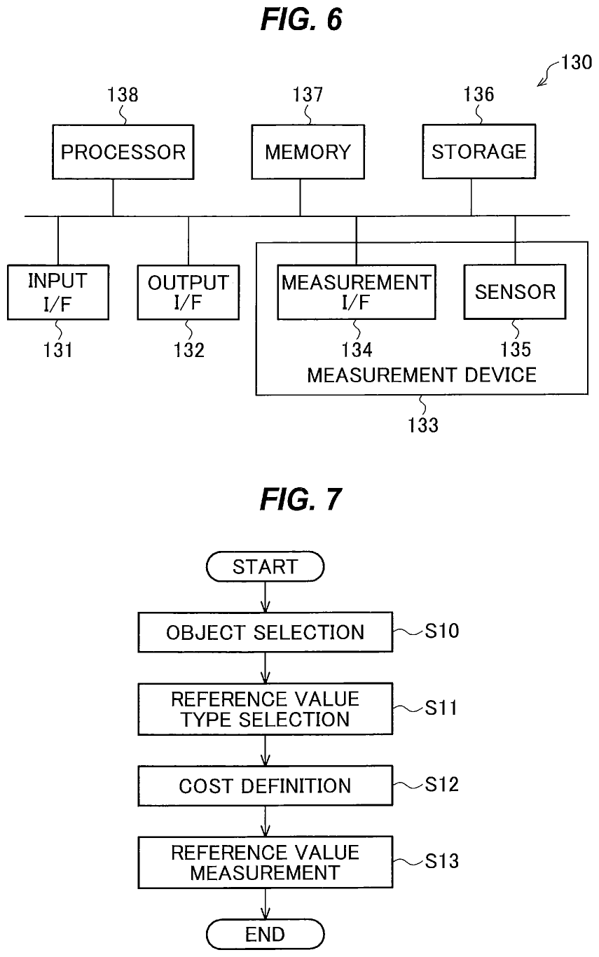

FIG. 6 is a block diagram schematically illustrating a hardware configuration example of the guidance device 100.

The guidance device 100 can be formed by a computer 130 including an input interface (referred to below as an input I/F) 131, an output interface (referred to below as an output I/F) 132, a measurement device 133, a storage 136, a memory 137, and a processor 138.

The input I/F 131 is a device, such as a keyboard, a mouse, a touch screen, or a VR controller, that can be interactively controlled. The input I/F 131 serves as the input unit 101.

The output I/F 132 is a hardware device, such as a display, a projector, or a speaker, that can be controlled by an electrical signal. The output I/F 132 is controlled by the object output unit 121.

The measurement device 133 is a device used for measuring various values. The measurement device 133 is controlled by the reference value measurement unit 113 or target position determination unit 103.

The measurement device 133 includes, for example, a measurement interface (referred to below as a measurement I/F) 134 and a sensor 135.

The measurement I/F 134 is a device that measures the reference values. For example, when an error from an estimated position is selected as a reference value, the measurement I/F 134 serves as a device, such as a mouse, a joystick, a touch screen, or a VR controller, for a user to perform pointing. When the time required for estimation is selected as a reference value, the measurement I/F 134 serves as a timer. When a line-of-sight movement distance is selected as a reference value, the measurement I/F 134 serves as a device such as an infrared sensor or an image sensor.

The measurement I/F 134 may measure a reference value by using questionnaires or the like used for subjective evaluation.

The sensor 135 is a device used for determining the target position. The sensor 135 is a device such as an acceleration sensor, a magnetic sensor, a gyroscope, an optical sensor, such as a human detection sensor, an image sensor, such as a camera, a distance sensor, or an ultrasonic sensor. The sensor 135 is controlled by the target position determination unit 103, and is used when the target position is not directly specified by a user.

Also, in the case of position guidance, such as car navigation, using a map, a global positioning system (GPS) or the like is also included in the sensor. Also, in the case of using an image sensor, by using a computer vision (CV) technology, such as tracking, in conjunction therewith, the target position can be detected more accurately.

The storage 136 is a non-volatile semiconductor memory, such as a read only memory (ROM), a flash memory, an erasable programmable read only memory (EPROM), or an electrically erasable programmable read only memory (EEPROM), a storage device, such as a hard disk drive (HDD), or a recording medium, such as a magnetic disc, a flexible disc, an optical disc, a compact disc, a mini disc, or a DVD. The storage 136 serves as the reference value storage unit 114, and is also used for storing a binary code of a program necessary for processing by the guidance device 100. Here, the binary code also includes information indicating the types of parameters, the definitions of the costs, or the types of reference values generated by the object selection unit 102, cost definition unit 111, or reference value type selection unit 112.

Although in the first embodiment, the storage 136 is included in the computer 130, the first embodiment is not limited to such an example. For example, the storage 136 may be another computer, a server, a cloud, or the like that can communicate with the computer 130.

The memory 137 is a volatile semiconductor memory, such as a random access memory (RAM), that temporarily holds a program executed by the processor 138 and various data. The memory 137 is used for temporarily storing some functions of an operating system (OS), a binary code of a program read by the OS, or data (e.g., the parameters, reference values, costs, or the like) managed by the processor 138.

The processor 138 is a processing device, such as a central processing unit (CPU), a microprocessor, a microcomputer, or a digital signal processor (DSP), that executes a program read from the memory 137. The processor 138 uses functions of the OS similarly read from the memory 137 to execute respective processes in the object selection unit 102, target position determination unit 103, parameter initialization unit 104, parameter correction unit 110, object generation unit 120, and object output unit 121 embedded in a program.

The program as described above may be provided through a network, or may be recorded and provided in a recording medium. Thus, such a program may be provided as a program product, for example.

FIG. 7 is a flowchart illustrating a process from the selection of the objects to the measurement of the reference values.

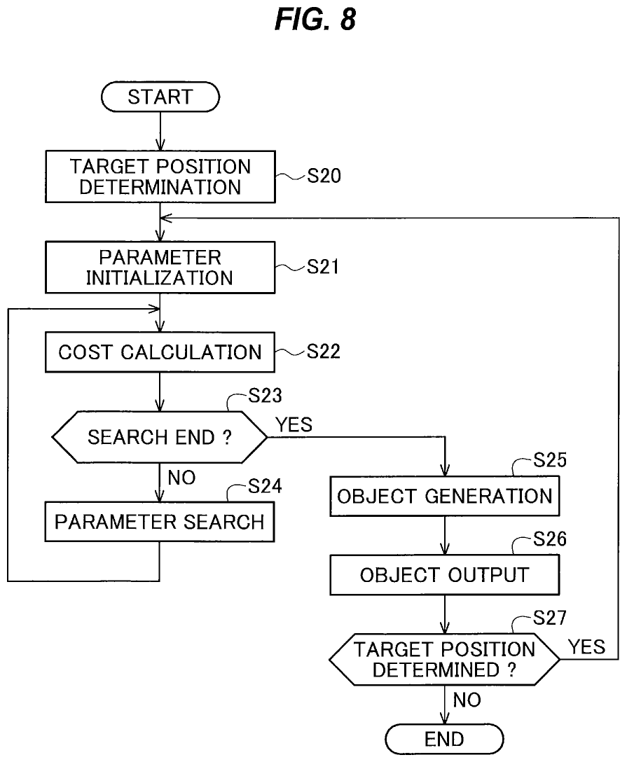

The process illustrated in FIG. 7 is an offline process performed offline. By previously performing such an offline process in the guidance device 100, it is possible to perform an online process illustrated in FIG. 8 any number of times thereafter.

Also, the offline process may be partially performed any number of times in response to changes in the application execution environment, instead of being performed only once. For example, when the display size is changed, performing the process in the reference value measurement unit 113 again allows the cost calculation unit 115 to obtain more accurate reference values.

First, the object selection unit 102 selects one or more objects to be presented to a user, and determines a list of one or more types of parameters for generating each object (S10).

Then, the reference value type selection unit 112 selects one or more types of reference values depending on the selected objects and determined parameters (S11).

Then, the cost definition unit 111 uses the reference values of the types selected by the reference value type selection unit 112 to define one or more costs and determine relational expressions between the costs and the reference values (S12).

Then, for the types of reference values selected by the reference value type selection unit 112, the reference value measurement unit 113 measures the reference values from responses of one or more users obtained using the measurement I/F 134, and stores the reference values in the reference value storage unit 114 such that the reference values are associated with the parameters (S13).

FIG. 8 is a flowchart illustrating a process from the determination of the target position to the output of the objects.

A process performed according to the flowchart illustrated in FIG. 8 is an online process, as described above.

First, the target position determination unit 103 determines the target position through the sensor 135 or input unit 101 (S20). Then, the target position determination unit 103 provides the determined target position to the parameter initialization unit 104. For example, the target position determination unit 103 provides a distance and a direction to the target position, to the parameter initialization unit 104.

Then, the parameter initialization unit 104 determines initial values of the parameters of the types determined by the object selection unit 102, on the basis of the provided target position (S21). Then, the parameter initialization unit 104 provides the determined initial values to the parameter search unit 116.

However, when the initial values are randomly determined, since they are independent of the target position, the parameter initialization unit 104 may perform the process before step S20.

Then, the cost calculation unit 115 calculates the costs by using the reference values corresponding to the current values of the parameters received from the reference value storage unit 114, according to the definitions of the costs provided from the cost definition unit 111 (S22). Then, the cost calculation unit 115 provides the calculated costs to the parameter search unit 116.

Then, the parameter search unit 116 checks the costs provided from the cost calculation unit 115 and determines whether to end cost search (S23). For example, the parameter search unit 116 may determine whether to end cost search, depending on whether a predetermined condition regarding the number of searches, the changes in the costs, or the like is satisfied. Then, when the condition is satisfied, the parameter search unit 116 determines to end cost search (Yes in S23), and advances the process to step S25. On the other hand, when the condition is not satisfied, the parameter search unit 116 determines to continue cost search (No in S23), and advances the process to step S24.

In step S24, the parameter search unit 116 performs parameter search by using the costs provided from the cost calculation unit 115, provides new values of the parameters to the cost calculation unit 115, and returns the process to step S22.

In step S25, the object generation unit 120 receives the values of the parameters from the parameter search unit 116, generates the objects on the basis of the values of the parameters, and provides output data for outputting the objects, to the object output unit 121.

Then, the object output unit 121 executes an application programming interface (API) of an external library and outputs the objects, by transmitting data for the objects to the output I/F 132 (S26).

Then, the target position determination unit 103 determines whether there is a target position waiting to be processed (S27). When there is a target position waiting to be processed (Yes in S27), the target position determination unit 103 provides the target position to the parameter initialization unit 104, and returns the process to step S21.

When there is no target position waiting to be processed (No in S27), the target position determination unit 103 places the program in a standby state until a target position is newly input. The online process ends when the application ends or when a person explicitly stops it.

As above, with the first embodiment, it is possible to provide a position guidance in which an estimation error due to the human cognitive process is small.

First Modification Although the first embodiment described above describes an example in which position guidance is performed by using part of an isosceles triangle, the first embodiment is not limited to such an example.

For example, Non Patent Literature 2 described below describes a technique called Halo that displays part of a circle on a display, thereby allowing a user to estimate a center position of the circle. Thereby, it is possible to guide the attention of the user to the center position.

Non Patent Literature 2: Patric Baudisch and Ruth Rosenholtz, “Halo: a technique for visualizing off-screen locations”, In Proceedings of the ACM Conference on Human Factors in Computing Systems (CHI 2003), 481-488.

When the technique described in Non Patent Literature 2 is used in the guidance device 100, the object selection unit 102 selects a circle as an object, and the radius of the circle is defined as a type of parameter.

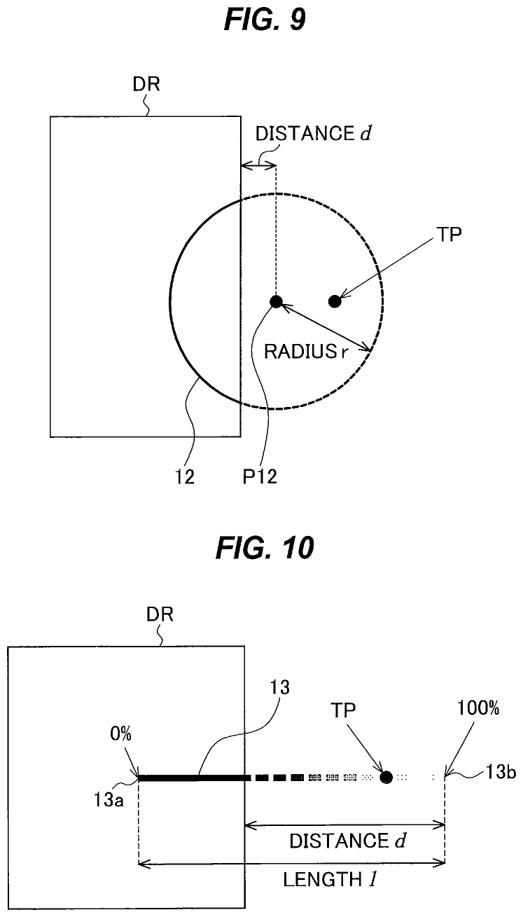

Specifically, when a circle 12 as illustrated in FIG. 9 is selected as an object, as parameters for determining the location of the circle 12 in the display region DR, two types, the radius r and the distance d from the center P12 of the circle 12 to the display region DR, are defined.

In this case, the target position determination unit 103 determines, as the target position, a position to which the attention is to be guided by the circle 12.

As described above, even when the apex position of the isosceles triangle does not coincide with the target position, accurate position guidance can be provided. Similarly, also in the case of the circle 12, the center P12 of the circle need not coincide with the target position TP.

These objects may be manually selected by a user depending on the application, or may be automatically selected according to a specific algorithm. For example, it is known that Halo has a problem in that, compared to Wedge, while the drawing area is large and the amount of information is large, figures are likely to overlap each other, which decreases the visibility. Thus, the objects may be selected depending on the situation, for example, as follows. When there is one target position, Halo is used, and when there are multiple target positions, Wedge is used.

### Second Modification

The object selection unit 102 may also select, as an object, a line 13 as illustrated in FIG. 10.

In this case, it is possible to monotonically increase the transparency from an end point 13a of the line on the display region DR side toward the other end point 13b, and guide the attention of the user toward a point at which the transparency is 100%.

In this case, similarly to the above, the end point 13b of the line 13 need not necessarily coincide with the target position TP. Thus, the object selection unit 102 may determine, as types of parameters, the distance d from the end point 13b to the display region DR and the length 1 of the line.

The transparency need not linearly change, and may non-linearly change. Thus, it is also possible to select a function, such as an exponential function or a quadratic function, that monotonically changes, and adopt one or more coefficients or the like of the function as one or more types of parameters.

### Third Modification

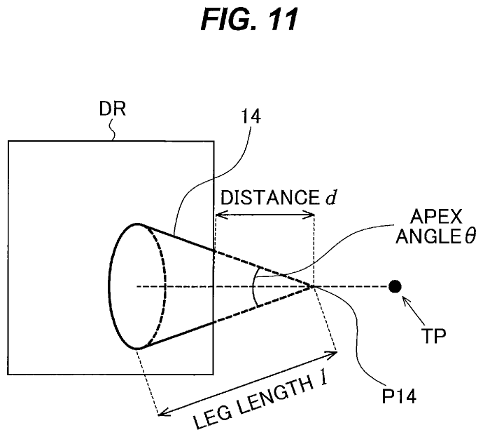

The object selection unit 102 may also select, as an object, a cone 14 as illustrated in FIG. 11.

The cone 14 can be considered as an extension of the above isosceles triangle 10 to three dimensions. Thus, types of parameters similar to those for the isosceles triangle 10 may be determined. The apex P14 of the cone 14 need not coincide with the target position TP, and the apex angle θ, the leg length l, and the distance d from the apex P14 to the display region DR may be determined as the types of parameters for determining the location of the cone 14.

### Fourth Modification

The object selection unit 102 may also select, as an object, an animated figure, i.e., a moving image.

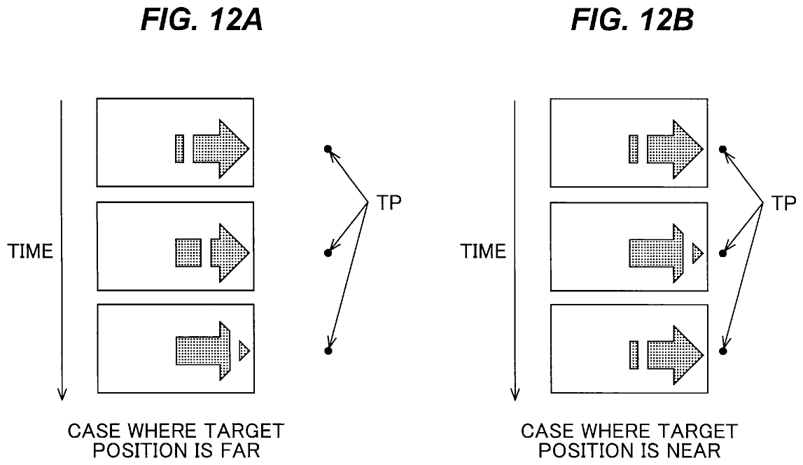

For example, the object selection unit 102 may select an animated figure such that a portion of an arrow changes to another color (e.g., yellow) and the portion moves toward the tip of the arrow with time, as illustrated in FIG. 12A or 12B.

In this case, when the animation is designed so that the movement speed of the portion increases as a distance to the target position TP decreases, the speed of the portion may be determined as a parameter.

The animated figure is an example, and instead of the portion moving, the transparency may change. Also, the figure may increase or decrease in size. In any of the cases, it is necessary to correct a parameter, such as a speed or period, related to time.

### Fifth Modification

The object selection unit 102 may also select, as an object, a sound reproduced from a speaker.

Here, a method of creating a virtual sound image by using a technique called amplitude panning will be described. Amplitude panning is a technique of providing intensity differences to sounds reproduced from two or more speakers, thereby creating a virtual sound image at a specific position at the same distance.

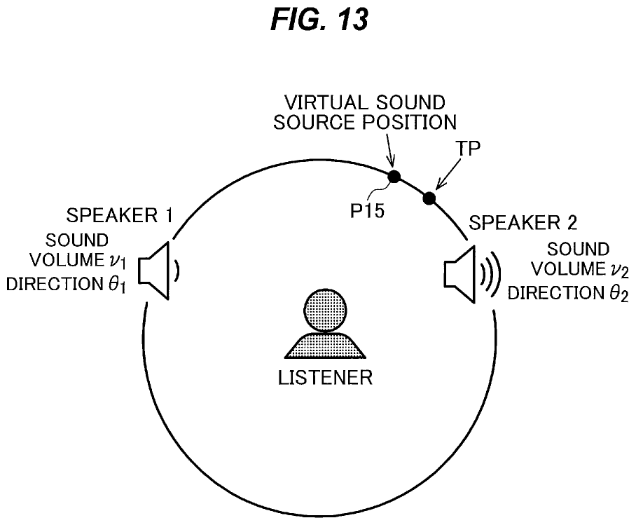

As illustrated in FIG. 13, when 2-channel speakers of speakers 1 and 2 are used, a virtual sound image can be created at a position at the same distance as speakers 1 and 2. Also in this case, similarly to the above, the position P15 of the virtual sound image need not necessarily coincide with the target position TP. Thus, the ratio v1/v2 of sound intensity between speakers 1 and 2 and the respective directions θ of speakers 1 and 2 may be determined as types of parameters for determining the position P15 of the virtual sound image.

### Second Embodiment

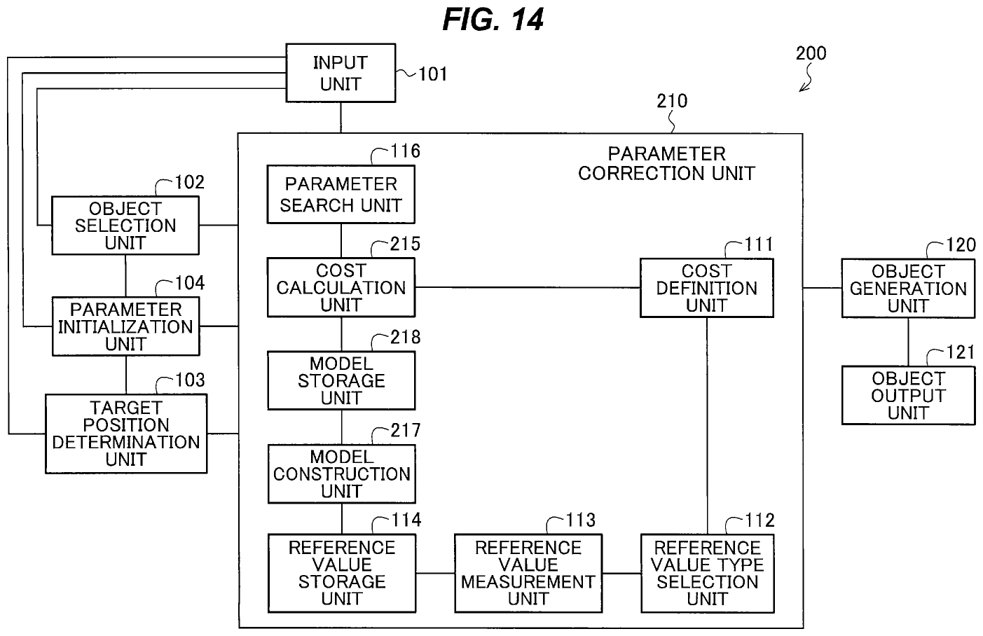

FIG. 14 is a block diagram schematically illustrating a configuration of a guidance device 200 according to a second embodiment.

The guidance device 200 includes an input unit 101, an object selection unit 102, a target position determination unit 103, a parameter initialization unit 104, a parameter correction unit 210, an object generation unit 120, and an object output unit 121.

The input unit 101, object selection unit 102, target position determination unit 103, parameter initialization unit 104, object generation unit 120, and object output unit 121 of the guidance device 200 according to the second embodiment are the same as the input unit 101, object selection unit 102, target position determination unit 103, parameter initialization unit 104, object generation unit 120, and object output unit 121 of the guidance device 100 according to the first embodiment.

Each time both the target position determined by the target position determination unit 103 and the initial values of the parameters determined by the parameter initialization unit 104 are input to the parameter correction unit 210, the parameter correction unit 210 provides corrected values of the parameters to the object generation unit 120.

The parameter correction unit 210 includes a cost definition unit 111, a reference value type selection unit 112, a reference value measurement unit 113, a reference value storage unit 114, a cost calculation unit 215, a parameter search unit 116, a model construction unit 217, and a model storage unit 218.

The cost definition unit 111, reference value type selection unit 112, reference value measurement unit 113, reference value storage unit 114, and parameter search unit 116 of the parameter correction unit 210 in the second embodiment are the same as the cost definition unit 111, reference value type selection unit 112, reference value measurement unit 113, reference value storage unit 114, and parameter search unit 116 of the parameter correction unit 110 in the first embodiment.

The cost calculation unit 215 calculates the costs from reference values corresponding to values of the parameters provided from the parameter search unit 116. Then, the cost calculation unit 215 provides the calculated costs to the parameter search unit 116.

Here, since the reference values used for calculating the costs in the cost calculation unit 215 affect the quality of the corrected values of the parameters, it is important to use more accurate reference values. However, in cases such as when the number of reference values stored in the reference value storage unit 114 is small, or when the values of the parameters provided from the parameter search unit 116 are rare values, the reference values may be low in accuracy.

The guidance device 200 according to the second embodiment includes the model construction unit 217 and model storage unit 218, and thereby can obtain more accurate reference values by using machine learning technology. Specifically, by using machine learning technology, the guidance device 200 according to the second embodiment can obtain accurate reference values while reducing the number of reference values that should be stored in the reference value storage unit 114, as compared to the first embodiment.

The model construction unit 217 constructs, from a discrete data set of values of the parameters and reference values corresponding to the values of the parameters stored in the reference value storage unit 114, a machine learning model representing a continuous correspondence relationship between the parameters and the reference values.

Specifically, the model construction unit 217 performs selection of a model, training of the model, and evaluation of the model. As the model, a parametric model (such as a normal distribution or a mixture distribution) that reflects domain knowledge may be selected, or a non-parametric model (such as a Gaussian process) that assumes no probability distribution form may be selected. Here, it is assumed that a Gaussian process regression model is constructed as the model, for example.

The model construction unit 217 uses, as training data, a data set held by the reference value storage unit 114 and trains a model according to a model such as maximum likelihood estimation based on mean squared error, cross entropy, or the like or Bayesian estimation with a prior distribution, or a learning criterion appropriate for the task. The trained model is evaluated by using data that was not used for the training, and a better model is created. At this time, a model evaluation index, such as mean squared error or coefficient of determination, may be appropriately selected depending on the task or learning criterion.

An example of a process by the model construction unit 217 will be described.

For example, the model construction unit 217 may read, from the reference value storage unit 114, a data set regarding the distance V_{B} that is a reference value, and perform training using a polynomial regression model, a Gaussian process regression model, or the like. In an experiment conducted by the inventor, a Gaussian process regression model fitted data better. Thus, one or more parameters of a kernel used in Gaussian process regression may be provided to the model storage unit 218.

The model storage unit 218 stores one or more parameters for a model that describes a continuous correspondence relationship between the parameters of the objects and the reference values corresponding to the parameters. For example, when the normal distribution is selected as the model, the model storage unit 218 stores only two types of parameters, the mean and variance.

The cost calculation unit 215 calculates reference values corresponding to values of the parameters provided from the parameter search unit 116 by using the model stored in the model storage unit 218, and calculates the costs by using the calculated reference values. Then, the cost calculation unit 215 provides the calculated costs to the parameter search unit 116.

An example of a process by the cost calculation unit 215 will be described.

The cost calculation unit 215 constructs a Gaussian process regression model by obtaining the model parameters from the model storage unit 218, and calculates the distance V_{B}, length direction standard deviation V_{L}, and width direction standard deviation V_{W}, which are reference values, by inputting, to the model, the target position determined by the target position determination unit 103 and the current values of the parameters provided from the parameter search unit 116. Then, the cost calculation unit 215 uses the reference values to calculate the Kullback-Leibler divergence as a cost, and provides the result to the parameter search unit 116.

Since the model construction unit 217 and model storage unit 218 as described above are provided, when the model is continuous and smooth, the parameter search unit 116 can search for values of the parameters by optimization (such as a steepest descent method) based on a gradient. Specifically, the parameter search unit 116 may calculate a gradient of the costs at the current values of the parameters, and search for values of the parameters in the direction.

The model construction unit 217 described above can also be implemented by the processor 138 illustrated in FIG. 6 executing a predetermined program. The parameters for the model that is being trained are stored in the memory 137.

The model storage unit 218 can be implemented by the storage 136.

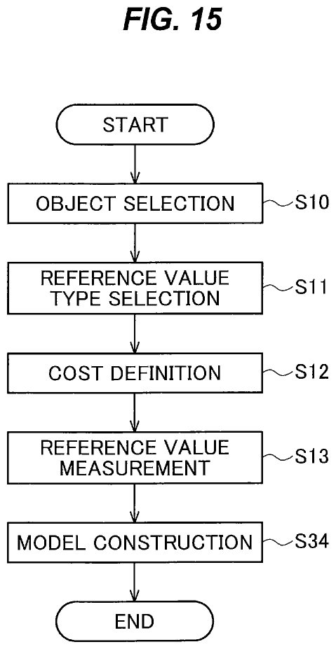

FIG. 15 is a flowchart illustrating a process from the selection of the objects to the measurement of the reference values in the second embodiment.

Here, of the steps included in the flowchart illustrated in FIG. 15, steps that perform the same processes as steps included in the flowchart illustrated in FIG. 7 are given the same reference characters as in FIG. 7.

The processes of steps S10 to S13 included in the flowchart illustrated in FIG. 15 are the same as the processes of steps S10 to S13 included in the flowchart illustrated in FIG. 7.

However, in FIG. 15, after the process of step S13, the process proceeds to step S34.

In step S34, the model construction unit 217 reads, from the reference value storage unit 114, a data set of values of the parameters and the reference values, trains a model, stores one or more parameters for the trained model in the model storage unit 218, and ends the offline process.

At this time, when the model construction unit 217 does not retrain the model, it may discard the data set from the reference value storage unit 114. The reference value storage unit 114 is not used in the online process, and thus it is possible to reduce the storage area (e.g., storage capacity) required by the reference value storage unit 114. However, it is noted that when it is not discarded, the model can be successively retrained.

Also in the second embodiment, the process from the determination of the target position to the output of the objects is performed according to the flowchart illustrated in FIG. 8.

However, in step S22, the cost calculation unit 215 calculates reference values corresponding to values of the parameters provided from the parameter search unit 116, by using the model stored in the model storage unit 218, and calculates the costs from the calculated reference values. Then, the cost calculation unit 215 provides the calculated costs to the parameter search unit 116.

As described above, with the second embodiment, the guidance device 200 can obtain more accurate reference values by using machine learning technology, and calculate the costs more accurately.

### Third Embodiment

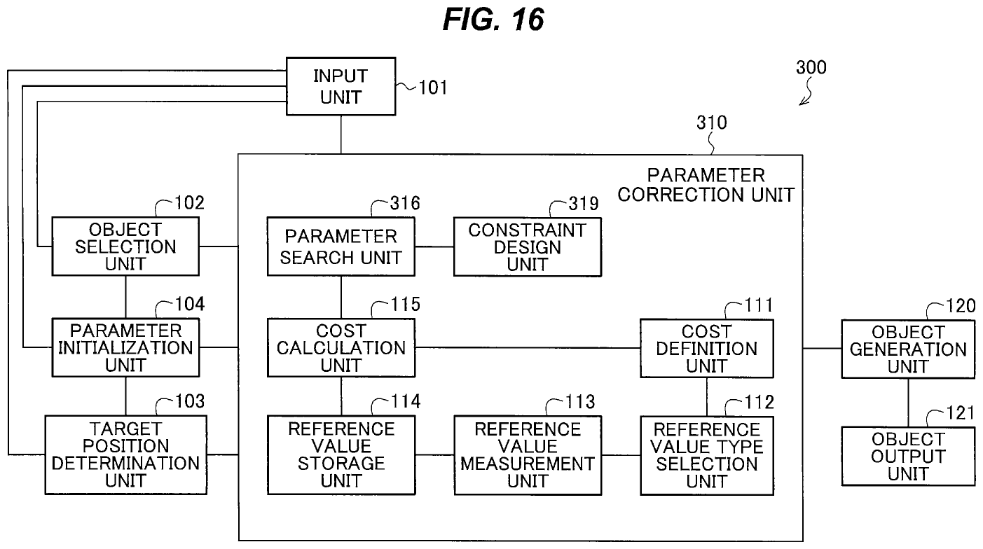

FIG. 16 is a block diagram schematically illustrating a configuration of a guidance device 300 according to a third embodiment.

The guidance device 300 includes an input unit 101, an object selection unit 102, a target position determination unit 103, a parameter initialization unit 104, a parameter correction unit 310, an object generation unit 120, and an object output unit 121.

The input unit 101, object selection unit 102, target position determination unit 103, parameter initialization unit 104, object generation unit 120, and object output unit 121 of the guidance device 300 according to the third embodiment are the same as the input unit 101, object selection unit 102, target position determination unit 103, parameter initialization unit 104, object generation unit 120, and object output unit 121 of the guidance device 100 according to the first embodiment.

Each time both the target position determined by the target position determination unit 103 and the initial values of the parameters determined by the parameter initialization unit 104 are input to the parameter correction unit 310, the parameter correction unit 310 provides corrected values of the parameters to the object generation unit 120.

The parameter correction unit 310 includes a cost definition unit 111, a reference value type selection unit 112, a reference value measurement unit 113, a reference value storage unit 114, a cost calculation unit 115, a parameter search unit 316, and a constraint design unit 319.

The cost definition unit 111, reference value type selection unit 112, reference value measurement unit 113, reference value storage unit 114, and cost calculation unit 115 of the parameter correction unit 310 in the third embodiment are the same as the cost definition unit 111, reference value type selection unit 112, reference value measurement unit 113, reference value storage unit 114, and cost calculation unit 115 of the parameter correction unit 110 in the first embodiment.

In the first embodiment, the parameter correction may cause unexpected operations. For example, when a length of a figure is corrected, it may become a negative value, and in the case of a sound, when the sound volume is too great, another problem such as noise may occur.

Thus, the third embodiment describes a method for ensuring stable operation by introducing the constraint design unit 319. Features described in the third embodiment may be added to the second embodiment.

The constraint design unit 319 specifies, for each parameter, a range of values that can be taken by the parameter.

Constraints on the parameters include constraints on the domains of the parameters and constraints unique to the execution environment. The former refers to constraints such as a constraint that lengths of figures take positive values. The latter refers to constraints such as a constraint that limits a figure drawing area depending on the size or shape of the display. The number of constraints is arbitrary, and the constraints may be loosened or tightened during execution of the online process.

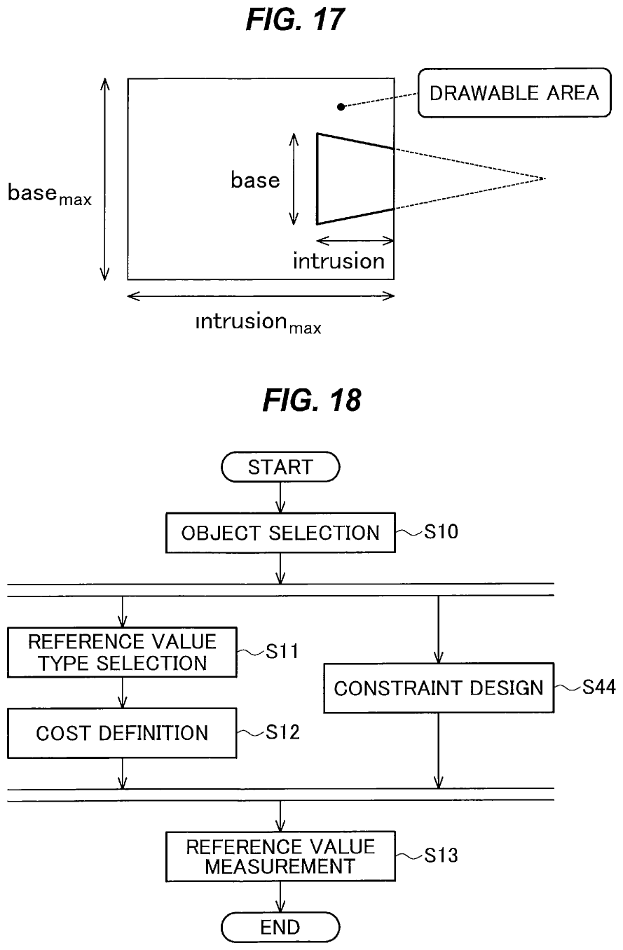

FIG. 17 illustrates an example of a process by the constraint design unit 319.

Here, new variables intrusion and base are introduced, and a constraint that specifies minimum and maximum values of each variable is designed. The variables can be calculated by using the apex angle θ, leg length l, and distance d, which are parameters.

In this constraint, by appropriately setting the maximum values depending on the size or shape of the display, it is possible to prevent the isosceles triangle from being displayed near a center of the display. With this constraint, it is possible to locate the figure in a peripheral visual field without covering content located in a central visual field.

The parameter search unit 316 updates the values of the parameters by using the target position determined by the target position determination unit 103 and searching for values of the parameters from the initial values of the parameters determined by the parameter initialization unit 104 so that the values called costs calculated by the cost calculation unit 115 are decreased, according to one or more constraints designed by the constraint design unit 319.

The parameter search unit 316 of the third embodiment needs to search for values of the parameters in view of the constraints. When no model is used as in the first embodiment, each time values of the parameters are obtained by the search, the parameter search unit 316 may check whether the values of the parameters satisfy the constraints. On the other hand, when a model is used as in the second embodiment, the parameter search unit 316 may update the values of the parameters in a direction such that the constraint conditions are satisfied. This can be implemented by solving a constrained optimization problem.

The constraint design unit 319 described above can also be implemented by the processor 138 illustrated in FIG. 6 executing a predetermined program. It is possible that a list of constraints designed by a user is stored as a binary code of a program in the storage 136, and the constraint design unit 319 automatically determines one or more constraints according to a specific algorithm designed by a user. For example, by designing an algorithm such that a figure drawing area is not more than one tenth of the area of the display, it is possible to automatically determine a constraint depending on the environment.

FIG. 18 is a flowchart illustrating a process from the selection of the objects to the measurement of the reference values in the third embodiment.

Here, of the steps included in the flowchart illustrated in FIG. 18, steps that perform the same processes as steps included in the flowchart illustrated in FIG. 7 are given the same reference characters as in FIG. 7.

The processes of steps S10 to S13 included in the flowchart illustrated in FIG. 18 are the same as the processes of steps S10 to S13 included in the flowchart illustrated in FIG. 7.

However, in FIG. 18, after the process of step S10, the process of step S44 is performed in parallel with the processes of steps S11 and S12.

In step S44, the constraint design unit 319 determines, for each parameter, the range of values taken by the parameter. Although the step need not necessarily be performed before step S13, it is preferable that the step be performed before step S13. This is because, when the constraints have been determined, as compared to when they have not been determined, the ranges of values of the parameters that should be tested in an experiment to subjects in step S13 are narrowed, and it is possible to efficiently collect reference values.

Also in the third embodiment, the process from the determination of the target position to the output of the objects is performed according to the flowchart illustrated in FIG. 8.

However, in step S24, the parameter search unit 316 refers to the constraints designed by the constraint design unit 319 and searches for values of the parameters at which the costs are low such that the constraints are satisfied.

### DESCRIPTION OF REFERENCE CHARACTERS

100, 200, 300 guidance device, 101 input unit, 102 object selection unit, 103 target position determination unit, 104 parameter initialization unit, 110, 210, 310 parameter correction unit, 111 cost definition unit, 112 reference value type selection unit, 113 reference value measurement unit, 114 reference value storage unit, 115, 215 cost calculation unit, 116, 316 parameter search unit, 217 model construction unit, 218 model storage unit, 319 constraint design unit, 120 object generation unit, 121 object output unit.

What is claimed is:

1. A guidance device comprising:
a processor to execute a program; and
a memory to store the program which, when executed by the processor, performs processes of:
determining a target position that is a position to which an attention of a user is to be guided by at least part of an object output to guide the attention of the user to a certain position by using estimation by the user;
determining an initial value of a parameter for outputting at least part of the object;
performing a search for a suitable value of the parameter for guiding the attention of the user to the target position by repeating a process of updating a value of the parameter of a determined type from the initial value so that an evaluation value approaches a predetermined value, and determining, from a result of the search, a value of the parameter for outputting at least part of the object, the evaluation value changing according to a difference between the target position and an estimated position that is a position estimated by a user from at least part of the object when at least part of the object is output;
generating output data for outputting at least part of the object, by using the determined value of the parameter; and
outputting at least part of the object by using the output data.

2. The guidance device of claim 1, wherein the evaluation value is a cost that increases in value as the difference between the estimated position and the target position increases.

3. The guidance device of claim 2, further comprising a reference value storage to store reference value information in which, for each of a plurality of values of the parameter, the value of the parameter is associated with one or more reference values indicating a magnitude of a difference between the target position and an estimated position estimated by a user from at least part of the object output according to the value of the parameter,
wherein the program further performs a process of calculating the cost by using the reference values.

4. The guidance device of claim 2, further comprising a reference value storage to store reference value information in which, for each of a plurality of values of the parameter, the value of the parameter is associated with one or more reference values indicating a magnitude of a difference between the target position and an estimated position estimated by a user from at least part of the object output according to the value of the parameter,
wherein the program further performs a process of constructing a machine learning model representing a continuous correspondence relationship between the parameter and the one or more reference values, by using the reference value information,
wherein the guidance device further comprises a model storage to store a parameter of the machine learning model, and
wherein the program further performs a process of calculating the one or more reference values corresponding to the initial value or the updated value of the parameter, by using the machine learning model, and calculating the cost by using the calculated one or more reference values.

5. The guidance device of claim 4, wherein the constructing constructs a Gaussian process regression model as the machine learning model.

6. The guidance device of claim 3, wherein the program further performs processes of:
selecting the object and determining a type of the parameter for outputting at least part of the object;
selecting one or more types of the one or more reference values from the object and the parameter of the determined type;
defining the cost on a basis of the selected one or more types;
from the definition, selecting a value of the parameter of the determined type, measuring the one or more reference values of the selected one or more types on a basis of the object output according to the selected value of the parameter, and storing, as the reference value information, in the reference value storage, the measured one or more reference values and the selected value of the parameter in an associated manner.

7. The guidance device of claim 4, wherein the program further performs processes of:
selecting the object and determining a type of the parameter for outputting at least part of the object;
selecting one or more types of the one or more reference values from the object and the parameter of the determined type;
defining the cost on a basis of the selected one or more types;
from the definition, selecting a value of the parameter of the determined type, measuring the one or more reference values of the selected one or more types on a basis of the object output according to the selected value of the parameter, and storing, as the reference value information, in the reference value storage, the measured one or more reference values and the selected value of the parameter in an associated manner.

8. The guidance device of claim 3, wherein
the one or more reference values are an amount of difference between the target position and a mean of the normal distribution and a standard deviation of the normal distribution when a distribution of a plurality of estimated positions estimated by a plurality of users from at least part of the object output according to each of a plurality of values of the parameter is regarded as a normal distribution, and
the cost is a pseudo distance between the normal distribution and an ideal normal distribution.

9. The guidance device of claim 4, wherein
the one or more reference values are an amount of difference between the target position and a mean of the normal distribution and a standard deviation of the normal distribution when a distribution of a plurality of estimated positions estimated by a plurality of users from at least part of the object output according to each of a plurality of values of the parameter is regarded as a normal distribution, and
the cost is a pseudo distance between the normal distribution and an ideal normal distribution.

10. The guidance device of claim 2, wherein the estimated position is a position estimated by the user from at least part of the object output in a virtual reality space according to a corresponding value of the parameter.

11. The guidance device of claim 1, wherein the program further performs a process of constraining a range of the parameter in which the search is performed.

12. The guidance device of claim 1, wherein the object is an isosceles triangle.

13. The guidance device of claim 1, wherein the object is a circle.

14. The guidance device of claim 1, wherein the object is a line.

15. The guidance device of claim 1, wherein the object is a cone.

16. The guidance device of claim 1, wherein the object is a moving image.

17. The guidance device of claim 1, wherein the object is a sound.

18. A non-transitory computer-readable recording medium storing a program for causing a computer to execute:
determining a target position that is a position to which an attention of a user is to be guided by at least part of an object output to guide the attention of the user to a certain position by using estimation by the user;
determining an initial value of a parameter for outputting at least part of the object;
performing a search for a suitable value of the parameter for guiding the attention of the user to the target position by repeating a process of updating a value of the parameter of a determined type from the initial value so that an evaluation value approaches a predetermined value, and determining, from a result of the search, a value of the parameter for outputting at least part of the object, the evaluation value changing according to a difference between the target position and an estimated position that is a position estimated by a user from at least part of the object when at least part of the object is output;
generating output data for outputting at least part of the object, by using the determined value of the parameter; and
outputting at least part of the object by using the output data.

19. A guiding method comprising:
determining a target position that is a position to which an attention of a user is to be guided by at least part of an object output to guide the attention of the user to a certain position by using estimation by the user;
determining an initial value of a parameter for outputting at least part of the object;
performing a search for a suitable value of the parameter for guiding the attention of the user to the target position by repeating a process of updating a value of the parameter of a determined type from the initial value so that an evaluation value approaches a predetermined value, and determining, from a result of the search, a value of the parameter for outputting at least part of the object, the evaluation value changing according to a difference between the target position and an estimated position that is a position estimated by a user from at least part of the object when at least part of the object is output;
generating output data for outputting at least part of the object, by using the determined value of the parameter; and
outputting at least part of the object by using the output data.
